(19) United States
(12) Patent Application Publication
(10) Pub. No.: US 2022/0036825 A1
(43) Pub. Date: Feb. 3, 2022

(54) PIXEL CIRCUIT AND PIXEL CONTROL METHOD

(71) Applicant: HUAWEI TECHNOLOGIES CO., LTD., Shenzhen (CN)

(72) Inventors: Yasuyuki TERANISHI, Tokyo (JP); Masafumi MATSUI, Osaka (JP); Kenichi TAKATORI, Tokyo (JP)

(21) Appl. No.: 17/502,244

(22) Filed: Oct. 15, 2021

Related U.S. Application Data
(63) Continuation of application No. PCT/CN2019/083298, filed on Apr. 18, 2019.

(51) Int. Cl. G09G 3/3233

(52) U.S. Cl. CPC G09G 3/3233; G09G 2310/061; G09G 2360/142; G09G 2310/0251

(57) ABSTRACT

Provided are a pixel circuit and a pixel control method capable of quickly controlling pixels with a simpler configuration of a combination of a photosensor and an image sensor. The pixel circuit includes a photosensor, and a dual gate transistor having a first gate connected to a first terminal of the photosensor, and a second gate connected to a pixel unit drive circuit, and a bias electrode connected to a second terminal of the photosensor. The dual gate transistor operates as a switch of the pixel unit drive circuit and an amplifier of the photosensor. A pulse level of the second gate is adaptively controlled.

### CROSS-REFERENCE TO RELATED APPLICATIONS

This application is a continuation of International Application No. PCT/CN2019/083298, filed on Apr. 18, 2019, the disclosure of which is hereby incorporated by reference in its entirety.

### TECHNICAL FIELD

The present disclosure relates to a pixel circuit and a pixel control method therefor, and, more particularly, to control of an image sensor combined with a photosensor.

### BACKGROUND ART

A conventionally known organic electroluminescent (EL) display is a flat panel display that uses an organic light emitting diode (OLED) as a display element and drives the OLED by current to emit light.

Generally, in the pixel circuit of an organic EL display, the driving transistor causes the current to flow to the OLED, so that the characteristics of the driving transistor are important. A thin film transistor (TFT) used as a driving transistor has a problem such that the threshold voltage is not uniform, and even if same data is input, different currents are generated to cause variations in luminance. Therefore, various pixel unit drive circuits are designed to compensate for variations in threshold voltage of individual TFTs. At present, a 6T1C (six transistors and one capacitor) circuit and a 7T1C (seven transistors and one capacitor) circuit are provided for each pixel as pixel unit drive circuits used for OLEDs of portable terminals. Thus, a large number of transistors implemented for one pixel are one factor to complicate the pixel circuit.

Further, a plurality of transistors are also used in an image sensor such as a CMOS sensor mounted on a portable terminal, which converts light into an electric signal. A CMOS image sensor includes an active pixel sensor (APS) that increases the gain of signals on a pixel-by-pixel basis to increase the signal-to-noise ratio (S/N ratio) of the image sensor. The structure of the APS includes, for each pixel, three TFTs: a transistor for resetting the voltage of a photodiode, a transistor for amplifying the gain, and a transistor for reading out the signal.

Therefore, when a pixel circuit is configured by mounting a pixel unit drive circuit such as 6T1C circuit or 7T1C circuit together with an APS structure used in an image sensor for a single pixel of the OLED, the circuit configuration becomes more complicated, thus requiring a larger footprint. This results in a reduction in the resolution of the image sensor. In addition, when the OLED and the APS structure individually occupy resources, it takes time to control the pixels.

### SUMMARY OF INVENTION

It is an objective of the present invention to provide a pixel circuit and a pixel control method capable of quickly controlling pixels with a simpler configuration of a combination of a pixel circuit and a photosensor.

According to a first aspect, there is provided a pixel circuit including:

a photosensor;

a dual gate transistor having a first gate connected to a first terminal of the photosensor, and a second gate connected to a pixel unit drive circuit; and

a bias electrode connected to a second terminal of the photosensor,

wherein

the dual gate transistor operates as a switch of the pixel unit drive circuit and an amplifier of the photosensor, and

a pulse level of the second gate is adaptively controlled.

The first aspect can provide a pixel circuit that quickly controls pixels with a simpler configuration of a combination of a pixel circuit and a photosensor.

According to a possible implementation of the first aspect, reading and resetting of the photosensor are performed between an initialization period of initializing the pixel unit drive circuit and a write period of precharging a voltage for driving a pixel unit.

According to this implementation, reading and resetting of the photosensor can be performed by using the precharge period.

According to a possible implementation of the first aspect, the pixel circuit further includes a reset transistor having a source connected to a reset voltage, and a drain connected to the first terminal of the photosensor, wherein the photosensor is reset by controlling a reset signal supplied to a gate of the reset transistor.

According to this implementation, resetting of the photosensor can be controlled by the reset transistor.

According to a possible implementation of the first aspect, the photosensor is reset by controlling a voltage of the bias electrode.

According to this implementation, the photosensor can be reset without adding a dedicated element.

According to a possible implementation of the first aspect, a voltage of a level between a high level and a low level is applied to the second gate in a period of reading the photosensor, and

discharging of charges stored in photosensor causes a current to flow through the dual gate transistor according to a voltage applied to the first gate.

According to this implementation, a current corresponding to discharging of the photosensor can be supplied by using a dual gate transistor.

According to a possible implementation of the first aspect, resetting and reading of the photosensor are performed sequentially for each scan line.

According to this implementation, an interval of writing data into an OLED can be shortened.

According to a possible implementation of the first aspect, resetting and reading of the photosensor are performed at a frequency less than a frequency of driving pixels by the pixel unit drive circuit.

According to this implementation, an interval of writing data into an OLED can be made shorter.

According to a second aspect, there is provided a pixel control method executed by a pixel circuit including a photosensor, a dual gate transistor having a first gate connected to a first terminal of the photosensor, and a second gate connected to a pixel unit drive circuit, and a bias electrode connected to a second terminal of the photosensor, the method including:

causing the dual gate transistor to operate as a switch of the pixel unit drive circuit; and

causing the dual gate transistor to operate as an amplifier of the photosensor, a pulse level of the second gate being adaptively controlled.

The second aspect can provide a method of quickly controlling pixels with a simpler configuration of a combination of a pixel circuit and a photosensor.

According to a possible implementation of the second aspect, the causing the dual gate transistor to operate as a switch of the pixel unit drive circuit includes:

initializing the pixel unit drive circuit; and

precharging a voltage for driving a pixel unit, and

the causing the dual gate transistor to operate as an amplifier of the photosensor includes, between the initializing and the precharging:

reading the photosensor; and

resetting the photosensor.

According to this implementation, reading and resetting of the photosensor can be performed by using the precharge period.

According to a possible implementation of the second aspect, the pixel circuit further includes a reset transistor having a source connected to a reset voltage, and a drain connected to the first terminal of the photosensor, and the resetting includes:

resetting the photosensor by controlling a reset signal supplied to a gate of the reset transistor.

According to this implementation, resetting of the photosensor can be controlled by the reset transistor.

According to a possible implementation of the second aspect, the resetting includes resetting the photosensor by controlling a voltage of the bias electrode.

According to this implementation, the photosensor can be reset without adding a dedicated element.

According to a possible implementation of the second aspect, the reading includes:

applying a voltage of a level between a high level and a low level to the second gate,

wherein discharging of charges stored in photosensor causes a current to flow through the dual gate transistor according to a voltage applied to the first gate.

According to this implementation, a current corresponding to discharging of the photosensor can be supplied by using a dual gate transistor.

According to a possible implementation of the second aspect, the reading is performed sequentially for each scan line.

According to this implementation, an interval of writing data into an OLED can be shortened.

According to a possible implementation of the second aspect, the reading is performed at a frequency less than a frequency of driving pixels by the pixel unit drive circuit.

According to this implementation, an interval of writing data into an OLED can be made shorter.

According to a third aspect, there is provided a display device including the above-mentioned pixel circuit.

The third aspect can provide a display device that quickly controls pixels with a simpler configuration of a combination of a pixel circuit and a photosensor.

### BRIEF DESCRIPTION OF DRAWINGS

FIG. 1 is a diagram showing an example of the configuration of a 6T1C circuit which is a pixel unit drive circuit used in an OLED;

FIG. 2 is a timing chart for the operation of the pixel unit drive circuit;

FIG. 3 is a diagram showing the configuration of a pixel unit drive circuit using the configuration of a 7T1C circuit;

FIG. 4 is a diagram showing the structure of an APS in an image sensor;

FIG. 5 is a diagram showing the configuration of a pixel unit drive circuit according to an embodiment of the present invention;

FIG. 6 is a timing chart for the operation of the pixel unit drive circuit;

FIG. 7 is an equivalent circuit diagram in an OLED reset period of the pixel unit drive circuit;

FIG. 8 is an equivalent circuit diagram in a PD read period of the pixel unit drive circuit;

FIG. 9 is an equivalent circuit diagram in a PD reset period of the pixel unit drive circuit;

FIG. 10 is an equivalent circuit diagram in an OLED write period of the pixel unit drive circuit;

FIG. 11 is a diagram showing the configuration of a pixel unit drive circuit according to an embodiment of the present invention;

FIG. 12 is a timing chart for the operation of the pixel unit drive circuit;

FIG. 13 is a timing chart for the operation of the pixel unit drive circuit;

FIG. 14 is a timing chart for the operation of the pixel unit drive circuit;

FIG. 15 is a timing chart for the operation of the pixel unit drive circuit; and

FIG. 16 is a diagram showing the configuration of a display device according to an embodiment of the present invention.

### DESCRIPTION OF EMBODIMENTS

### First Embodiment

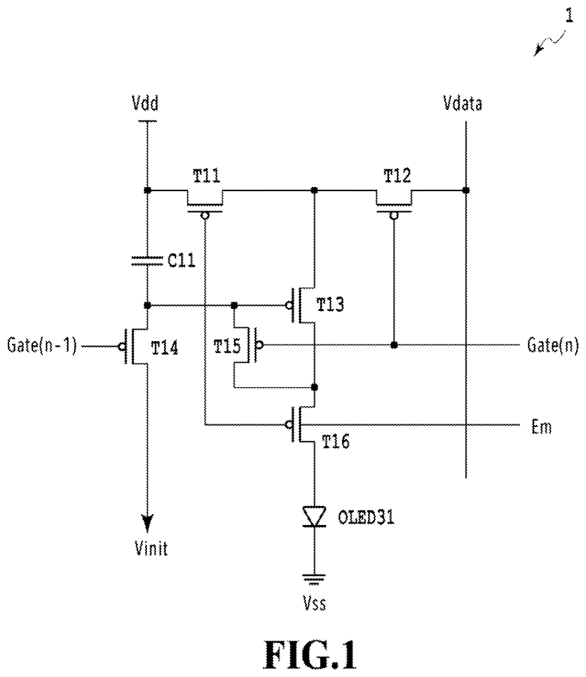

First, the operational principle of the present embodiment will be described with reference to FIGS. 1 to 4.

FIG. 1 is a diagram showing an example of the configuration of a 6T1C circuit which is a pixel unit drive circuit used in an OLED. This pixel unit drive circuit 1 drives and controls pixels for each pixel unit, and one subpixel corresponds to a pixel unit in the following description. This pixel unit drive circuit 1 includes one OLED 31, six transistors T11 to T16, and one capacitor C11. One OLED 31 corresponds to a subpixel of one color of red (R), green (G) and blue (B) subpixels constituting one pixel.

The pixel unit drive circuit 1 includes the switching transistor T12 for, in response to a scan (gate) signal Gate(n) applied to the nth scan line, switching a data signal of a voltage level Vdata applied to the corresponding data line. The pixel unit drive circuit 1 also includes the driving transistor T13 that supplies a drive current for the OLED 31 according to a charge voltage corresponding to a data signal input to the driving transistor T13 via the switching transistor T12, and the compensation transistor T15 for compensating for a threshold voltage of the driving transistor T13. The pixel unit drive circuit 1 further includes the capacitor C11 for storing the data signal applied to the gate of the driving transistor T13, and the OLED 31 that emits light corresponding to the applied drive current.

Further, the pixel unit drive circuit 1 includes the switching transistor T11 for supplying the power supply voltage Vdd to the driving transistor T13 in response to an emission signal Em, and the switching transistor T16 for supplying the drive current input to the OLED 31 in response to the emission signal Em. The driving transistor T13 supplies the switching transistor T16 with a voltage which is decreased from the power supply voltage Vdd according to a resistance value of the driving transistor T13 determined by the input to the gate of the driving transistor T13. The transistors T11 to T16 are configured as a p-type thin film transistor (TFT).

The switching transistor T12 has a gate to which the nth scan signal Gate(n) applied to the corresponding scan line is applied, a source to which a data signal of a voltage level Vdata applied to the corresponding data line is applied, and a drain connected to the source of the driving transistor T13.

The driving transistor T13 has the gate connected to one terminal of the capacitor C11, and a drain connected to one terminal of the OLED 31 via the switching transistor T16. The compensation transistor T15 has a drain connected to the gate of the driving transistor T13, a source respectively connected to the drain of the driving transistor T13, and a gate to which the scan signal Gate(n) is applied. The power supply voltage Vdd of a high level is supplied from the corresponding power supply to the other terminal of the capacitor C11.

The switching transistor T11 has a gate to which the emission signal Em is applied, a source to which the power supply voltage Vdd is applied through the corresponding power supply voltage line, and a drain connected to the source of the driving transistor T13. The switching transistor T16 has a gate to which the emission signal Em is applied, a source connected to the drain of the driving transistor T13, and a drain connected to one terminal of the OLED 31. The other terminal of the OLED 31 is connected to a power supply of a voltage Vss.

Further, the pixel unit drive circuit 1 includes the reset transistor T14 for initializing a data signal stored in the capacitor C11 in response to a scan signal Gate(n−1) applied to the (n−1)th scan line immediately before the nth scan line. The reset transistor T14 has a gate to which the scan signal Gate(n−1) is applied, a source connected to one terminal of the capacitor C11, and a drain to which an initialization voltage Vinit is applied.

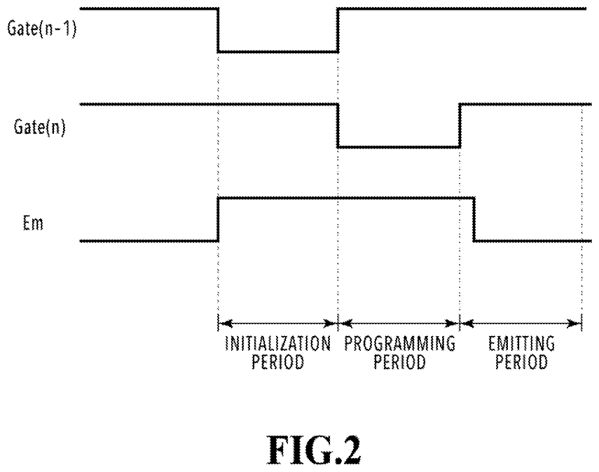

FIG. 2 is a timing chart for the operation of the pixel unit drive circuit 1 shown in FIG. 1. In an initialization period, the (n−1)th scan signal Gate(n−1) is at a low level, and the nth scan signal Gate(n) and the emission signal Em are at a high level. The low-level scan signal Gate(n−1) turns the reset transistor T14 on, and the high-level scan signal Gate(n) and emission signal Em turn the other transistors T11 to T13, T15, and T16 off. Therefore, the data signal stored in the capacitor C11 is initialized, thus initializing the gate voltage of the driving transistor T13.

Next, in a precharge period, the scan signal Gate(n−1) is at a high level, the scan signal Gate(n) is at a low level, and the emission signal Em is at a high level. The reset transistor T14 is turned off, the low-level scan signal Gate(n) turns the compensation transistor T15 and the switching transistor T12 on, and the emission signal Em turns the switching transistors T11 and T16 off. Therefore, the data signal of the voltage level Vdata applied to the corresponding data line is applied to the source of the driving transistor T13, and the gate voltage of the driving transistor T13 is stabilized to Vdata+threshold voltage Vth of the driving transistor T13 via the compensation transistor T15, and electric charges corresponding to the gate voltage are stored in the capacitor C11, which completes a precharge operation.

In an emission period, the scan signal Gate(n−1) is at a high level, and the emission signal Em goes low after the scan signal Gate(n) goes high. The low-level emission signal Em turns the switching transistors T11 and T16 on, the high-level scan signal Gate(n−1) turns the reset transistor T14 off, and the high-level scan signal Gate(n) turns the compensation transistor T15 and the switching transistor T12 off. As a result, Vdd is applied to the source of the driving transistor T13, and a gate-source voltage Vgs of the driving transistor T13 becomes

Vgs=Vdata+Vth−Vdd,

and a current I flowing through the OLED 31 is given by

I=k·(Vgs−Vth)2=k·(Vdata+Vth−Vdd−Vth)2=k·(Vdata−Vdd)2

so that a current which does not depend on the threshold voltage flows through the OLED 31, causing the OLED 31 to emit light.

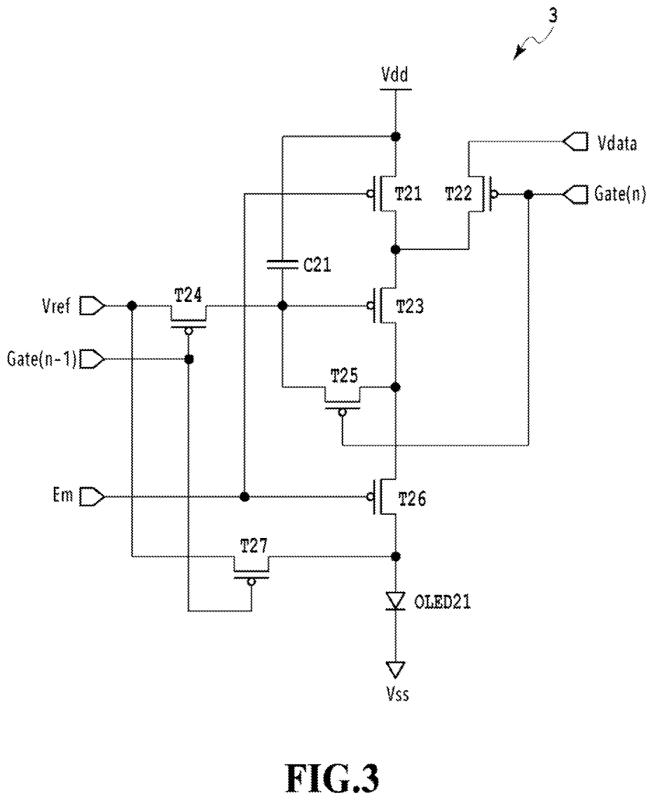

FIG. 3 is a diagram showing the configuration of a pixel unit drive circuit using the configuration of a 7T1C circuit. The pixel unit drive circuit 3 includes a switching transistor T22 for, in response to a scan signal Gate(n) applied to the nth scan line, switching a data signal of a voltage level Vdata applied to the corresponding data line. The pixel unit drive circuit 3 also includes a driving transistor T23 that supplies a drive current for an organic EL element according to a charge voltage corresponding to a data signal input to the driving transistor T23 via the switching transistor T22, and a compensation transistor T25 for compensating for a threshold voltage of the driving transistor T23. The pixel unit drive circuit 3 further includes a capacitor C21 for storing the data signal of a voltage level applied to the gate of the driving transistor T23, and an organic EL element OLED 21 that emits light corresponding to the applied drive current.

Moreover, the pixel unit drive circuit 3 includes a switching transistor T21 for supplying a power supply voltage Vdd to the driving transistor T23 in response to an emission signal Em, and the switching transistor T26 for supplying a drive current input to the OLED 21 in response to the emission signal Em. The driving transistor T23 supplies the switching transistor T26 with a voltage which is decreased from the power supply voltage Vdd according to a resistance value of the driving transistor T23 determined by the input to the gate of the driving transistor T23. The pixel unit drive circuit 3 also includes a reset transistor T24 for initializing a data signal stored in the capacitor C21 in response to a scan signal Gate(n−1) applied to the (n−1)th scan line immediately before the nth scan line. The pixel unit drive circuit 3 further includes reset transistor T27 which has a source connected to a line of a reference voltage Vref, a gate connected to the scan signal Gate(n−1), and a drain connected to the OLED 21. The transistors T21 to T27 are configured as a p-type thin film transistor (TFT).

In the pixel unit drive circuits shown in FIGS. 1 and 3, a large number of transistors implemented for one pixel become a factor to complicate the circuit.

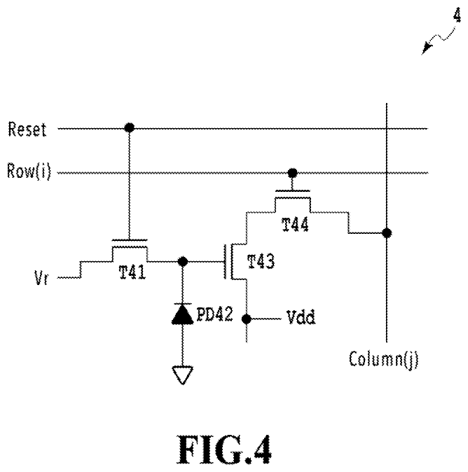

FIG. 4 is a diagram showing the structure of an APS in an image sensor. The APS 4 includes, for each subpixel, three TFTs: a reset transistor T41 for resetting a voltage of a photodiode (PD) 42, an amplification transistor T43 for amplifying the gain of a signal from the PD 42, and a read transistor T44 for reading a signal. The PD 42 forms a pn junction with a p-type semiconductor layer on the reception side and an n-type semiconductor layer on the substrate side. When a reverse bias is applied to the pn junction, the pn junction becomes a depletion layer for the junction hardly has carriers. When light having energy greater than that of the band gap of the semiconductor is irradiated in the vicinity of the depletion layer, carriers are generated. The PD 42 may normally be configured as a PIN photodiode. The PIN photodiode includes three layers, namely p+-Si, i-Si and n+-Si, and electrodes disposed with this layer structure in between. In the case of the PIN photodiode, the presence of the i layer widens the width of the depletion layer obtained when the reverse bias is applied, thus allowing the PIN photodiode to be used under a high reverse bias voltage. The high reverse bias voltage in the wide depletion layer quickly moves the carriers, thus improving the response speed.

In a reset period of the APS 4, the reset transistor T41 operates as a switch for resetting a floating fusion to Vr, in which case the floating fusion is expressed as a gate of the amplification transistor T43. The amplification transistor T43 has a capability of amplifying a signal by changing the current according to the voltage of the gate. In the example shown in FIG. 4, when the gate voltage becomes low, the current easily flows. When a reset signal Reset from a reset signal line turns the reset transistor T41 on, the PD 42 is connected to the power supply of the voltage Vr to charge initial charges. Then, in a read period, the reset transistor T41 is turned off, and a dark current is increased by irradiating light on the PD 42, so that the stored initial charges are discharged. At this time, a potential on the cathode side of the PD 42 varies according to the light intensity, so that the amplification transistor T43 amplifies the signal flowing from a power supply of a power supply voltage Vdd and supplies the signal to the jth column line Column(j). The read transistor T44 allows a single row of the pixel array to be read by a reading electronic circuit.

When the pixel unit drive circuit using the 6T1C circuit shown in FIG. 1 or the 7T1C circuit shown in FIG. 3 and the APS shown in FIG. 4 used in an image sensor are implemented together, therefore, the circuit configuration becomes complicated. This complication requires more footprint, thus lowering the resolution of the image sensor.

According to the present embodiment, the dual gate transistor is used in the combination of the pixel unit drive circuit and the APS to make the configuration simpler. The dual gate transistor is used both for transfer of the signal in the OLED and amplification of the PD signal. For the dual gate transistor and the photodiode in an image sensor, for example, three-dimensional active pixel sensor PD (3D APS PD) constituted by a dual gate transistor and a photodiode in an image sensor can be used.

In the combination of the pixel unit drive circuit with the APS, one problem is how to reset a photodiode. The present embodiment provides a method of resetting the photodiode and quickly reading the photodiode with a simple configuration.

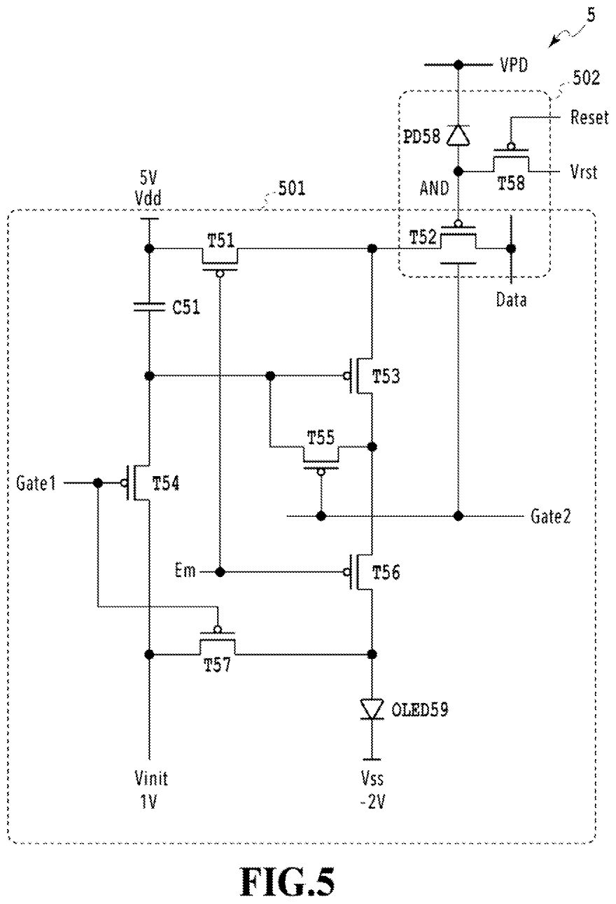

FIG. 5 is a diagram showing the configuration of a pixel circuit 5 including a combination of a pixel unit drive circuit 501 and an image sensor 502 according to the present embodiment. The pixel unit drive circuit 501 uses a 7T1C circuit, and compensates for the threshold voltage Vth of the driving transistor.

The pixel unit drive circuit 501 includes a switching transistor T52 for, in response to a scan (gate) signal Gate2 applied to a second scan line, switching a data signal of a voltage level Vdata applied to the corresponding data line. The pixel unit drive circuit 501 also includes a driving transistor T53 that supplies a drive current for an OLED 59 according to a charge voltage corresponding to a data signal input to a source of the driving transistor T53 via the switching transistor T52, and a compensation transistor T55 for compensating for a threshold voltage of the driving transistor T53. The pixel unit drive circuit 501 further includes a capacitor C51 for storing the data signal applied to the gate of the driving transistor T53, and the OLED 59 that emits light corresponding to the applied drive current.

Moreover, the pixel unit drive circuit 501 includes a switching transistor T51 for supplying a power supply voltage Vdd of 5V to the driving transistor T53 in response to an emission signal Em, and the switching transistor T56 for supplying a drive current input to the OLED 59 in response to the emission signal Em. The driving transistor T53 supplies the switching transistor T56 with a voltage which is decreased from the power supply voltage Vdd according to a resistance value of the driving transistor T53 determined by the input to the gate of the driving transistor T53. The pixel unit drive circuit 501 also includes reset transistors T54, T57 for initializing a data signal stored in the capacitor C51 in response to a scan signal Gate1 applied to a first scan line immediately before the second scan line. The transistors T51 to T57 are configured as a p-type thin film transistor (TFT).

The switching transistor T52 is configured as a dual gate transistor including a top gate (first gate) transparent to visible light and a bottom gate (second gate) non-transparent to visible light. The top gate (first gate) is connected to an anode-side first terminal of a PD 58, and the bottom gate (second gate) is connected to the pixel unit drive circuit 501 via the corresponding second scan line. The switching transistor T52 has a source to which a data signal of a voltage level Vdata applied to the corresponding data line is applied, and a drain connected to a source of the driving transistor T53. As will be described later, the switching transistor T52 which is a dual gate transistor operates as a switch of the pixel unit drive circuit 501 and an amplifier of the PD 58.

The driving transistor T53 has a gate connected to one terminal of the capacitor C51, and a drain connected to one terminal of the OLED 59 via the switching transistor T56. The compensation transistor T55 has a drain connected to the gate of the driving transistor T53, a source connected to the drain of the driving transistor T53, and a gate to which the scan signal Gate2 is applied. The power supply voltage Vdd of 5V is supplied from the corresponding power supply to The other terminal of the capacitor C51.

The switching transistor T51 has a gate to which the emission signal Em is applied, a source to which the power supply voltage Vdd is applied through the corresponding power supply voltage line, and a drain connected to the source of the driving transistor T53. The switching transistor T56 has a gate to which the emission signal Em is applied, a source connected to the drain of the driving transistor T53, and a drain connected to one terminal (anode) of the EL element OLED 59. The other terminal of the EL element OLED 59 is connected to a power supply of a voltage Vss of −2V.

The reset transistor T54 has a gate to which the scan signal Gate1 is applied, a source connected to one terminal of the capacitor C51, and a drain to which an initialization voltage Vinit is applied. The reset transistor T57 has a source connected to a power supply whose initialization voltage Vinit is 1V, a gate connected to the first scan line, and a drain connected to the anode of the OLED 59.

Next, the configuration of the image sensor 502 will be described. The image sensor 502 includes the PD 58 which is a photosensor, a reset transistor T58, and the switching transistor T52 which is shared by the pixel unit drive circuit 501. The PD 58 has the anode-side terminal (first terminal) connected to the top gate of the switching transistor T52, and a cathode-side terminal (second terminal) connected to a bias electrode for a bias voltage VPD. The reset transistor T58 has a gate connected to a reset signal line, a source connected to a power supply of a voltage Vrst, and a drain connected to the anode of the PD 58.

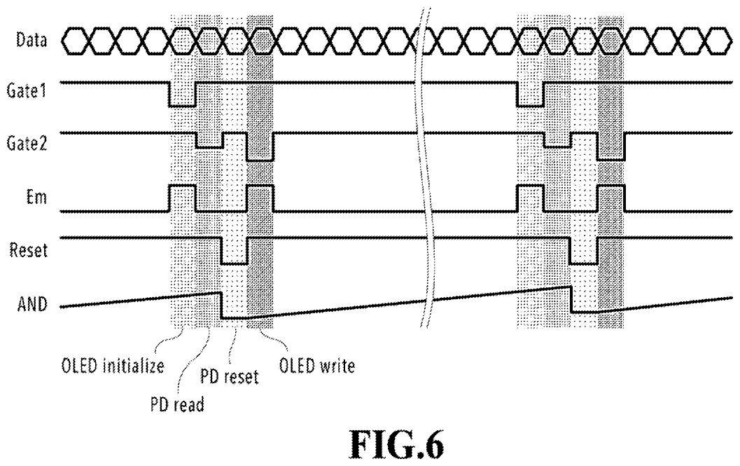

Next, procedures of a pixel control method that is executed by the pixel circuit 5 shown in FIG. 5 will be described with reference to a timing chart in FIG. 6. According to the present embodiment, reading and resetting are performed between the initialization period in which the pixel unit drive circuit 501 initializes the pixel unit, and the write period in which a voltage for driving the pixel unit is precharged.

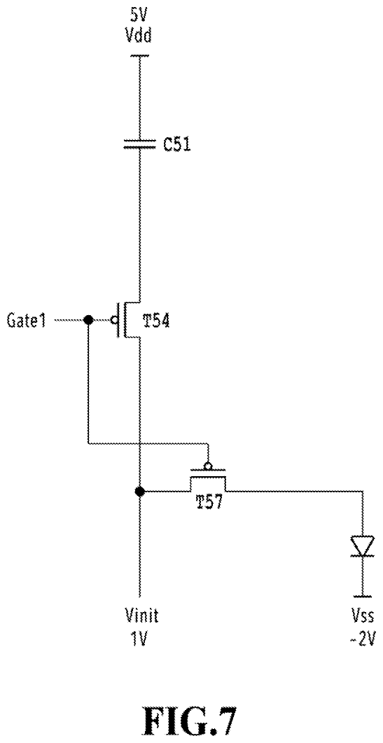

In an initialization period, the first scan signal Gate1 is at a low level, and the second scan signal Gate2 and the emission signal Em are at a high level. In addition, the bias voltage VPD at the cathode of the PD 58 is at a high level, and a potential AND at the anode thereof is close to the high level. The low-level scan signal Gate1 turns the reset transistors T54, T57 on, and the high-level scan signal Gate2 and emission signal Em turn the other transistors T51 to T53, T55, and T56 off. Therefore, the pixel unit drive circuit 501 takes a circuit configuration as shown in FIG. 7, so that the data signal stored in the capacitor C51 is initialized, thus causing the initialization voltage Vinit to be applied to the gate of the driving transistor T53. Consequently, the reset transistor T57 is turned on, so that the initialization voltage Vinit is also applied to the OLED 59.

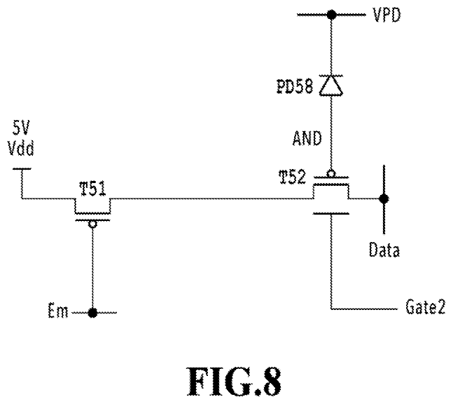

Next, reading of the PD 58 (PD reading) and resetting thereof (PD resetting) are performed. In the PD read period, the scan signal Gate1 is at a high level. Meantime, the pulse level of the scan signal Gate2 to be supplied to the bottom gate (second gate) of the switching transistor T52 is adaptively controlled to be a middle between the low level and the high level. In addition, the emission signal Em is at a low level, the reset signal Reset is at a high level, and the anode-side potential AND of the PD 58 is almost at a high level. The reset transistors T54, T57 are turned off, and the switching transistors T51, T56 are turned on by the emission signal Em. Therefore, the pixel unit drive circuit 501 takes a circuit configuration as shown in FIG. 8, so that irradiation of light onto the PD 58 causes discharge of the initial charges stored therein. Because an intermediate voltage is applied to the switching transistor T52 by the scan signal Gate2 at this time, a current according to the voltage at the top gate is supplied to the data line Data from the power supply of the power supply voltage Vdd.

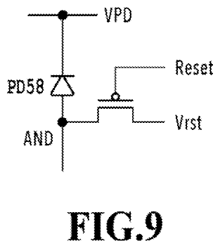

Next, in the PD reset period, the scan signal Gate1 is at a high level, the scan signal Gate2 is at a high level, the emission signal Em is at a low level, the reset signal Reset is at a low level, and the anode potential AND of the PD 58 is at a low level. Therefore, the pixel unit drive circuit 501 takes a circuit configuration as shown in FIG. 9, so that the anode of the PD 58 is connected to the power supply of the voltage Vrst. This Vrst is lower than the bias voltage VPD on the cathode side of the PD 58, so that the PD 58 is reset. Thereafter, the pixel array T58 stays off until a next reset period, and irradiation of light onto the PD 58 gradually increases the anode potential AND, so that the anode potential AND approaches the bias voltage VPD.

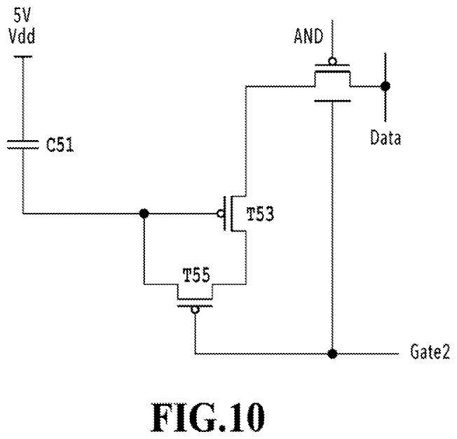

Next, in the OLED write period, the scan signal Gate1 is at a high level, the scan signal Gate2 is at a low level, and the emission signal Em is at a high level. Further, the reset signal Reset is at a high level, and the anode potential AND is at a low level. Therefore, the reset transistors T54, T57 are turned off, the switching transistors T51, T56 are turned off, and the compensation transistor T55 and the driving transistor T53 are turned on. The scan signal Gate2 also turns the switching transistor T52 on, and the emission signal Em turns the switching transistors T51, T56 off, so that the pixel unit drive circuit 501 takes a circuit configuration as shown in FIG. 10. Consequently, the data signal of the voltage level Vdata to be applied to the corresponding data line is applied to the source of the driving transistor T53, the gate voltage of the driving transistor T53 is stabilized to be Vdata+Vth, where Vth is the threshold voltage of the driving transistor T53. Then, electric charges corresponding to the gate voltage are stored in the capacitor C51, which completes the precharge operation.

Finally, at the time of emission, the scan signal Gate1 is at a high level, the emission signal Em goes low after the scan signal Gate2 goes high, then, the reset signal Reset goes high, and the anode potential AND goes low. As a result, the low-level emission signal Em turns the switching transistors T51, T56 on, the high-level scan signal Gate1 turns the reset transistors T54, T57 off, and the high-level scan signal Gate2 turns the compensation transistor T55 and the switching transistor T52 off. Consequently, the drive current which is generated according to the charge voltage corresponding to the data signal input to the gate of the driving transistor T53 is supplied via the transistor T53 to the OLED 59, thus causing the OLED 59 to emit light.

According to the present embodiment, as described above, in the combination of the OLED and the APS, resetting and reading of the PD can be performed quickly.

### Second Embodiment

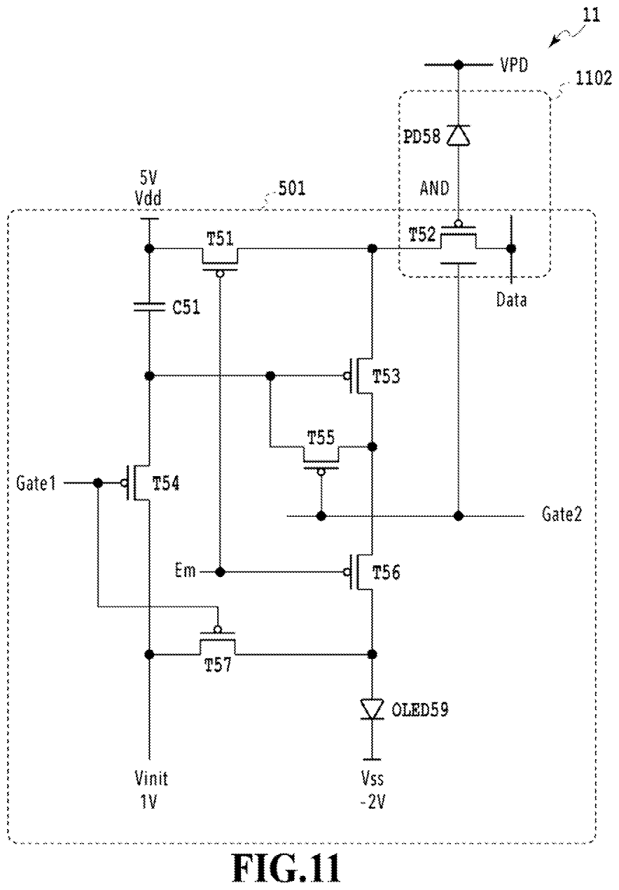

FIG. 11 is a diagram showing the configuration of a pixel circuit 11 including a combination of a pixel unit drive circuit 501 and an image sensor 110 according to another embodiment of the present invention. The pixel circuit 11 differs from the pixel circuit 5 shown in FIG. 5 in that the pixel circuit 11 does not have the reset transistor T58. In this embodiment, the PD 58 is reset by controlling the bias voltage VPD on the cathode side of the PD 58.

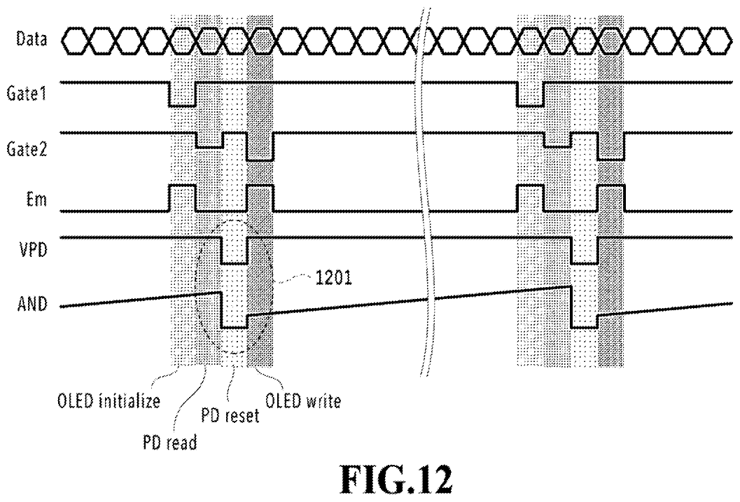

Procedures of a pixel control method that is executed by the pixel circuit 11 shown in FIG. 11 will be described with reference to a timing chart in FIG. 12. Operations in the initialization period and the PD read period are the same as the operations described above with reference to FIG. 6. In the PD reset period, as indicated by a circle 1201, the bias voltage VPD goes low at the same time as the anode potential AND goes low. When the anode potential AND is set high and the bias voltage VPD is set low by controlling the bias voltage VPD, the current flows through the PD 58 in a forward bias direction, thus resetting the anode potential AND.

In the next PD reset period, the anode potential AND starts at a level slightly higher than the level in the PD reset period, due to the parasitic capacitance in the PD 58.

As apparent from the above, the PD can be reset by controlling the bias voltage VPD in the combination of the OLED and the APS without requiring an additional reset transistor in the image sensor.

### Third Embodiment

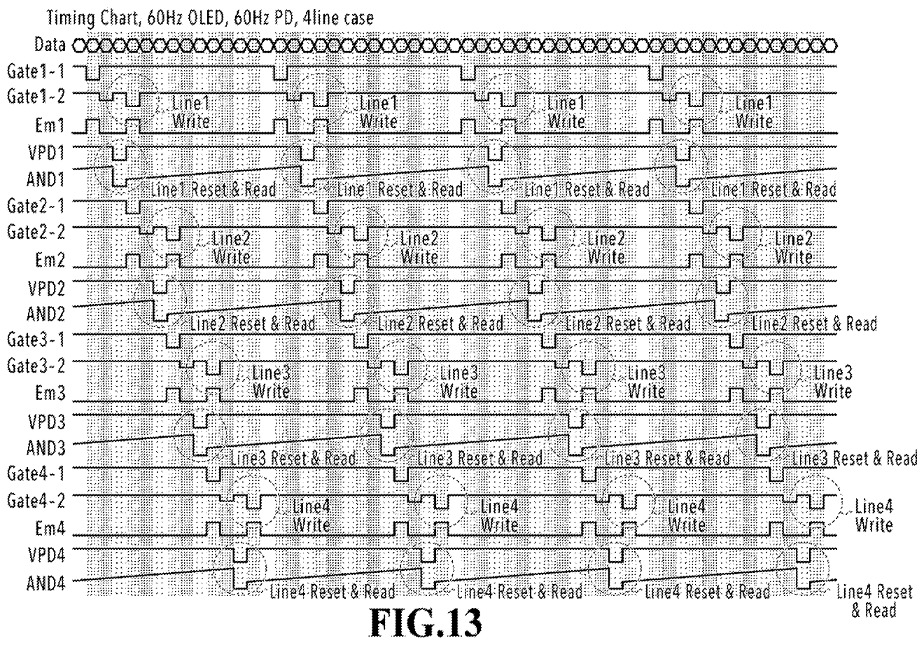

FIGS. 13 to 15 are timing charts for describing an example of controlling the frequency of resetting the PD 58 in the above-described pixel circuit. In FIGS. 13 to 15, Gaten−1 and Gaten−2 respectively indicate the first scan signal and the second scan signal on the nth scan line. Further, numerals added to Em1, VPD1, AND1, etc. indicate the number of scan line.

FIG. 13 shows an example where in an OLED having a refresh rate of 60 Hz, data writing to the OLED and resetting and reading of the PD are performed at the same frequency sequentially for each of four scan lines. Normally, data writing to the OLED takes about 1 μs. As mentioned above, when resetting and reading of the PD are added between resetting and writing of the OLED every time, the data writing interval becomes longer accordingly. In the case of a display with 2000 to 3000 scan lines, slow display operation becomes prominent.

Accordingly, in the present embodiment, the frequency of resetting and reading the PD is set lower than the frequency of writing the OLED to shorten the data writing interval.

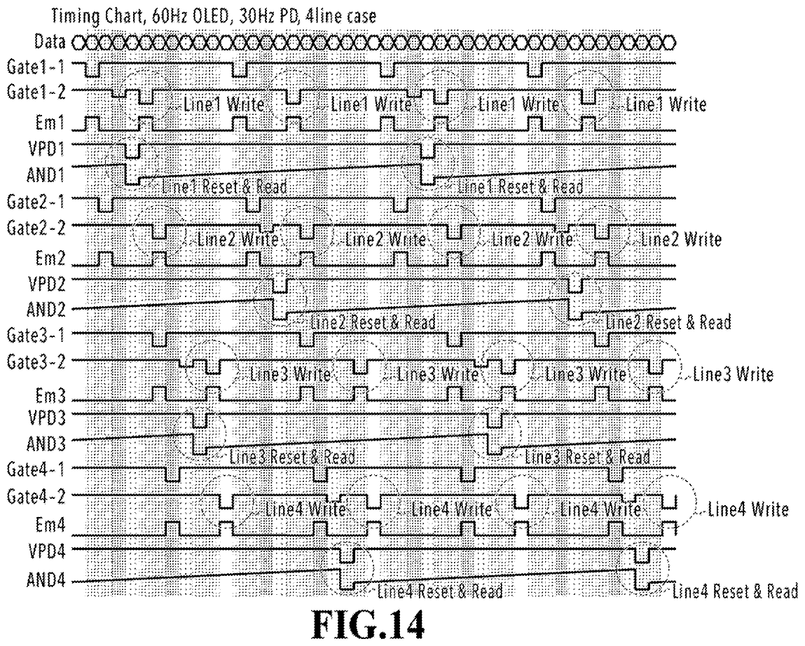

FIG. 14 shows a case where for four scan lines in the OLED with a refresh rate of 60 Hz, the frequency of resetting and reading the PD is set to 30 Hz. Specifically, while data writing to the OLED is sequentially performed for each scan line, resetting and reading of the PD for a single scan line are performed once for every two data-writing operations. In the example shown in FIG. 4, resetting and reading of the PD are first performed for odd-numbered scan lines, and are then performed for even-numbered scan lines.

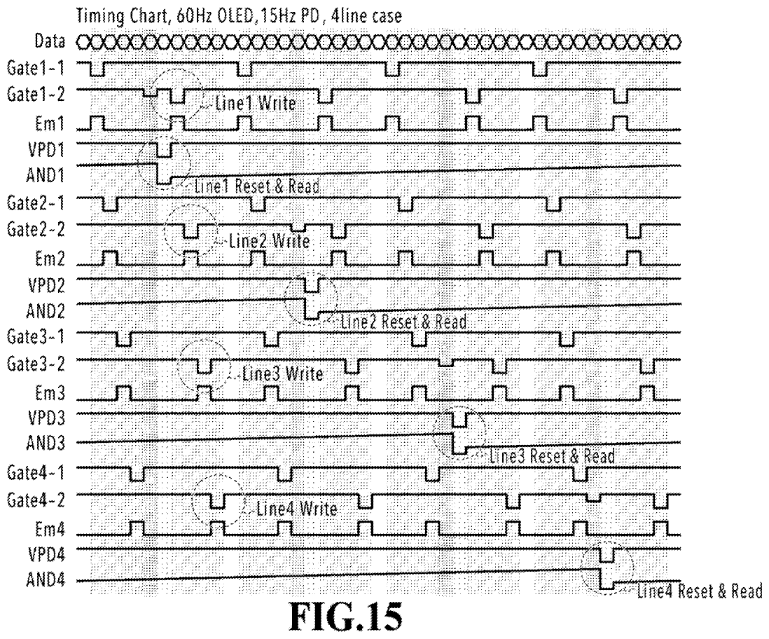

FIG. 15 shows a case where for four scan lines in the OLED with a refresh rate of 60 Hz, the frequency of writing data to the OLED and the frequency of resetting and reading the PD are set to 15 Hz. Specifically, while data writing to the OLED is sequentially performed for each scan line, resetting and reading of the PD for a single scan line are performed once in four times.

Setting the frequency of resetting and reading the PD lower than the frequency of driving pixels by the pixel unit drive circuit allows the data writing operation for next scan lines to be performed faster. As a result, the interval of the data writing for the same scan line can be shortened.

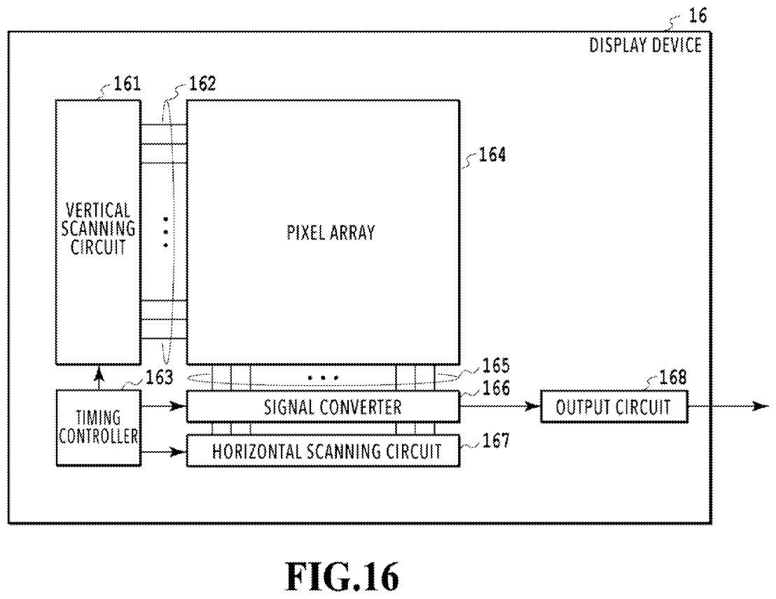

FIG. 16 is a block diagram showing an example of the configuration of a display device including a pixel circuit according to an embodiment of the present invention. A display device 16 includes the above-described pixel circuit and a screen, wherein the pixel circuit is used to control the screen. The pixel circuit is included in a pixel array 164. The pixel array 164 has a plurality of pixel circuits arrayed in N rows by M columns two-dimensionally (in a matrix form). A vertical scanning circuit 161 that supplies a pixel drive signal is disposed on one end side (left side in the figure) of the pixel array 164. The pixel array 164 and the vertical scanning circuit 161 are connected to each other by signal lines 162. Further, a signal converter 166 and a horizontal scanning circuit 167, which are connected to individual column signal lines 165, are disposed on the lower end side (lower side in the figure) of an imaging area.

The display device 16 includes a timing controller 163. The timing controller 163 generates and outputs a master clock or a clock obtained by frequency-dividing the master clock based on the master clock. The vertical scanning circuit 161, the signal converter 166, and the horizontal scanning circuit 167 are controlled in synchronism with the clock output from the timing controller 163.

The vertical scanning circuit 161 sets an address and controls the vertical scanning. The signal converter 166 performs signal conversion processing such as conversion of an analog output from a pixel to a digital output, and outputs the converted signal to an output circuit 168. The horizontal scanning circuit 167 sequentially selects the signal converter 166 in synchronism with the clock output from the timing controller 163, and reads the signal and outputs the signal to the output circuit 168. The output circuit 168 converts the digital outputs converted in the signal converter 166 to signals corresponding to the color array, and outputs the converted signals.

The pixel circuit constituted by the combination of the OLED and the APS according to each of the embodiments described above can be adapted to various electronic devices, such as a portable telephone, smartphone, personal digital assistant (PDA) and PC.

It is to be noted that making the reading surface of the image sensor and the display surface the same surface allows an image to be read by using light irradiated from the display surface. Such processing is effective for fingerprint authentication, for example.

Although the foregoing embodiments exemplify the configuration in which the pixel unit drive circuit includes six or seven transistors and one capacitor, the quantities of transistors and capacitors and the circuit configuration are not limited to the examples described above, and can be modified in various other forms.

The foregoing descriptions are merely specific implementation manners of the present invention, but are not intended to limit the protection scope of the present invention. Any variation or replacement readily figured out by a person skilled in the art within the technical scope disclosed shall fall within the protection scope of the present invention. Therefore, the protection scope of the present invention shall be subject to the protection scope of the claims.

1. A pixel circuit comprising:
a photosensor;
a dual gate transistor having a first gate connected to a first terminal of the photosensor, and a second gate connected to a pixel unit drive circuit; and
a bias electrode connected to a second terminal of the photosensor,
wherein the dual gate transistor operates as a switch of the pixel unit drive circuit and an amplifier of the photosensor, and
a pulse level of the second gate is adaptively controlled.

2. The pixel circuit according to claim 1, wherein
reading and resetting of the photosensor are performed between an initialization period of initializing the pixel unit drive circuit and a write period of precharging a voltage for driving a pixel unit.

3. The pixel circuit according to claim 1, further comprising a reset transistor having a source connected to a reset voltage, and a drain connected to the first terminal of the photosensor, wherein the photosensor is reset by controlling a reset signal supplied to a gate of the reset transistor.

4. The pixel circuit according to claim 1, wherein the photosensor is reset by controlling a voltage of the bias electrode.

5. The pixel circuit according to claim 1, wherein
a voltage of a level between a high level and a low level is applied to the second gate in a period of reading the photosensor, and
discharging of charges stored in the photosensor causes a current to flow through the dual gate transistor according to a voltage applied to the first gate.

6. The pixel circuit according to claim 1, wherein
resetting and reading of the photosensor are performed sequentially for each scan line.

7. The pixel circuit according to claim 1, wherein
resetting and reading of the photosensor are performed at a frequency less than a frequency of driving pixels by the pixel unit drive circuit.

8. A pixel control method executed by a pixel circuit comprising a photosensor, a dual gate transistor having a first gate connected to a first terminal of the photosensor, and a second gate connected to a pixel unit drive circuit, and a bias electrode connected to a second terminal of the photosensor, the method comprising:
causing the dual gate transistor to operate as a switch of the pixel unit drive circuit; and
causing the dual gate transistor to operate as an amplifier of the photosensor, a pulse level of the second gate being adaptively controlled.

9. The method according to claim 8, wherein
the causing the dual gate transistor to operate as a switch of the pixel unit drive circuit includes:
initializing the pixel unit drive circuit; and
precharging a voltage for driving a pixel unit, and
the causing the dual gate transistor to operate as an amplifier of the photosensor includes, between the initializing and the precharging:
reading the photosensor; and
resetting the photosensor.

10. The method according to claim 9, wherein the pixel circuit further comprises a reset transistor having a source connected to a reset voltage, and a drain connected to the first terminal of the photosensor, and the resetting includes:
resetting the photosensor by controlling a reset signal supplied to a gate of the reset transistor.

11. The method according to claim 9, wherein the resetting includes resetting the photosensor by controlling a voltage of the bias electrode.

12. The method according to claim 8, wherein
the reading includes:
applying a voltage of a level between a high level and a low level to the second gate,
wherein discharging of charges stored in the photosensor causes a current to flow through the dual gate transistor according to a voltage applied to the first gate.

13. The method according to claim 8, wherein
the reading is performed sequentially for each scan line.

14. The method according to claim 8, wherein
the reading is performed at a frequency less than a frequency of driving pixels by the pixel unit drive circuit.

15. A display device comprising:
a pixel circuit and a screen, wherein the pixel circuit comprising:
a photosensor;
a dual gate transistor having a first gate connected to a first terminal of the photosensor, and a second gate connected to a pixel unit drive circuit; and
a bias electrode connected to a second terminal of the photosensor,
wherein the dual gate transistor operates as a switch of the pixel unit drive circuit and an amplifier of the photosensor, and
a pulse level of the second gate is adaptively controlled;
and the pixel circuit is used to control the screen.
